(19) United States
(12) Patent Application Publication
(10) Pub. No.: US 2026/0342913 A1
(43) Pub. Date: Oct. 29, 2026

(54) Visual Interactive Voice Response Sessions

(71) Applicant: TEACHERS INSURANCE AND ANNUITY ASSOCIATION OF AMERICA, New York, NY (US)

(72) Inventors: Ramesh Mucharla, Concord, NC (US); Murali Ravipati, Concord, NC (US); Monyke Kindle, Harrisburg, NC (US); Sridhar Rada, Markham (CA); Akash Kumbhare, Pune (IN); Scott Andrew Lutz, Lewisville, TX (US); Shafiq N. Kassam, Lewisville, TX (US); Ajit I. Naidu, Wyckoff, NJ (US)

(21) Appl. No.: 19/188,888

(22) Filed: Apr. 24, 2025

(51) Int. Cl. H04M 3/493; G06F 16/955

(52) U.S. Cl. CPC H04M 3/493; G06F 16/9558

(57) ABSTRACT

The methods disclosed herein relate to providing a communication service. A method may include receiving, by one or more processors, a communication from a user device on a first communication channel of a first type. The user device may be associated with an authenticated user of the communication service. The method may include enabling, by the one or more processors and based on the communication with the user device over the first communication channel, access for the user device to a second communication channel of a second type. The method may include transmitting, to the user device by the one or more processors, access information for accessing the second communication channel. The method may include communicating, by the one or more processors, with the user device concurrently on the first communication channel and the second communication channel subsequently to transmitting the access information.

### TECHNICAL FIELD

The present disclosure is generally directed to methods and systems for integration of interactive voice response systems and visual devices.

### BACKGROUND

Many organizations have call centers to provide services to their clients. Call centers may comprise an interactive voice response (IVR) system that interacts with a calling party over the telephone network through signaling in the public switched telephone network (PSTN). An IVR system may provide information to or collect information from callers, allowing organizations to cut down on the need for live service representative to receive calls and route them correctly. Alternatively, the entire call may take place over the IVR system, without the need for interaction with a service representative.

Clients may initiate voice calls with services providers to seek information, resolve issues, make purchases, make complaints, or for other reasons. Many of these calls may be handled automatically or completed using voice communication. However, when calls are made using only one communication mode, it may be difficult to accurately convey all types of information. For example, callers with auditory impairments may have difficulty communicating using voice calls. Similarly, some types of information cannot be easily entered using purely voice calls.

### SUMMARY

Based on user request or upon detection of other properties of a user communication, a communication service may communicate simultaneously with a user on a first channel and a second channel, wherein the first channel and second channel are of two different types.

In an exemplary embodiment, a computer-implemented method for providing a communication service includes (receiving, by one or more processors, a communication from a user device on a first communication channel of a first type, the user device being associated with an authenticated user of the communication service; enabling, by the one or more processors and based on the communication with the user device over the first communication channel, access for the user device to a second communication channel of a second type; transmitting, to the user device by the one or more processors, access information for accessing the second communication channel; and communicating, by the one or more processors, with the user device concurrently on the first communication channel and the second communication channel subsequently to transmitting the access information. The method may include more or fewer actions, including those discussed elsewhere herein.

In an exemplary embodiment, a computing system for providing a communication service includes one or more processors; and one or more non-transitory memories, the one or more non-transitory memories having stored thereon computer-executable instructions that, when executed by the one or more processors, cause the one or more processors to receive a communication from a user device on a first communication channel of a first type, the user device being associated with an authenticated user of the communication service; enable, based on the communication with the user device over the first communication channel, access for the user device to a second communication channel of a second type; transmit, to the user device, access information for accessing the second communication channel; and/or communicate with the user device concurrently on the first communication channel and the second communication channel subsequently to transmitting the access information. The system and/or processors therein may perform other functions described elsewhere herein.

In an exemplary embodiment, a computer-readable medium including instructions that, when executed on a processor, cause the processor to perform operations for providing a communication service, including receiving a communication from a user device on a first communication channel of a first type, the user device being associated with an authenticated user of the communication service; enabling, based on the communication with the user device over the first communication channel, access for the user device to a second communication channel of a second type; transmitting, to the user device, access information for accessing the second communication channel; and/or communicating with the user device concurrently on the first communication channel and the second communication channel subsequently to transmitting the access information. The operations more or fewer actions, including those discussed elsewhere herein.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Additional, alternate, and/or fewer actions, steps, features, and/or functionality may be included in an aspect and/or embodiments, including those described elsewhere herein. Accordingly, the drawings and description are to be regarded as illustrative in nature and not as restrictive.

### BRIEF DESCRIPTION OF THE DRAWINGS

FIG. 1 illustrates a block diagram of an example computing system for providing a communication service in accordance with an example aspect of the present disclosure;

FIG. 2 illustrates a flow diagram associated with an interaction of a user with a first channel and a second channel in accordance with an example aspect of the present disclosure;

FIG. 3 illustrates a display of a user device during communication with a communication service in accordance with example aspects of the present disclosure;

FIG. 4 illustrates messaging and data flow between modules of a computing system for providing a communication service in accordance with an example aspect of the present disclosure; and

FIG. 5 illustrates a flow diagram representing an exemplary method for providing a communication service in accordance with an example aspect of the present disclosure.

### DETAILED DESCRIPTION

Systems according to methods of the embodiments provide multiple communication modes, simultaneously during a given customer interaction, upon demand or request by a customer. Therefore, systems may allow various types of data entry or interaction and may be more useful in helping customers with auditory or visual impairments to interact with call centers and call center staff.

Generally speaking, similar events and entities are labeled with similar reference numbers that share two least significant digits, with differences discussed below where appropriate.

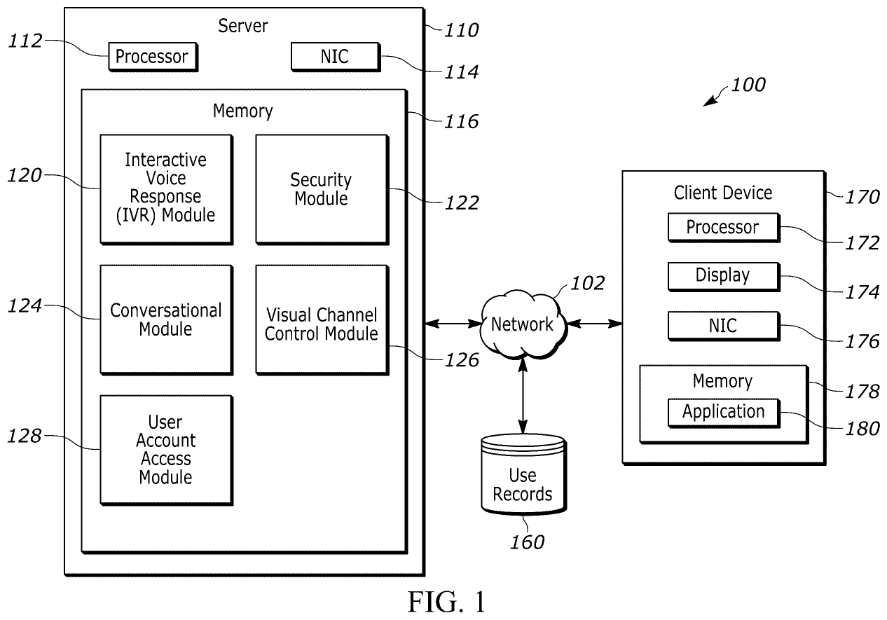

FIG. 1 illustrates various aspects of an example computing system 100 for providing a communication service. The computing system 100 may include one or more servers 110, and client devices 170, which may be communicatively connected through a network 102 as described below. One or more components of the computing system 100 may be provided by virtual instances (e.g., one or more cloud-based virtualization services).

The server 110 may be associated with (e.g., owned/operated by) a company that sells and/or provides any type of service or product, and that provides call center support for those services and products. The server 110 may be an individual server, a group (e.g., cluster) of multiple servers, or another suitable type of computing device or system (e.g., a collection of cloud computing resources). The server 110 may include one or more processors 112, a network interface 114, and memory 116.

The one or more processors 112may include any suitable number of processors and/or processor types, such as one or more central processing units (CPUs) and/or one or more graphics processing units (GPUs). Generally, the processor 112 may be configured to execute software instructions stored in a memory 116.

The server 110 may further include a network interface 114, such as wired and/or wireless controllers (e.g., Ethernet controllers). The network interface 114 facilitates communication over the network 102 between the server 110 and other components of the computing system 100.

The memory 116 may include one or more persistent memories (e.g., read only memory (ROM), a hard drive, solid state memory, computer-readable non-transitory memory, etc.) and/or one or more transitory memories (e.g., a random access memory (RAM) and/or cache). The memory 116 may include an operating system, one or more software applications, one or more software modules, and/or one or more machine learning (ML) models. The operating system may include any suitable operating system, such as Microsoft Windows, Linux, or UNIX. The memory 116 may include an Interactive Voice Response (IVR) module 120, a security module 122, a conversational module 124, a visual channel control module 126, and a user account access module 128.

With reference to the IVR module 120, IVR may include an automated phone system to provide a pre-recorded voice menu to users and receive user input over phone keypads, thereby enabling communication over a first communication channel of a first (e.g., voice) type. as described in further detail later herein, the IVR module 120 may query a caller/user, receive feedback, and route a call to an appropriate service representative. In some embodiments, the IVR 120 may include a web-integrated IVR. In some embodiments, a query may include providing a voice-based question that requests the return of further information. For example, a query may include request for a user's identity or reason for calling. Feedback may include a caller/user voice response to the query, a keypad press, or other input provided by the caller/user to the IVR module 120. Based on the feedback, the IVR module 120 may select the appropriate agent based on the skills of the agent and the reason for the call, using for example a database lookup to match one or more agents to the call. For example, the IVR module 120 may match agents based on foreign language skills, or on ability to service a particular kind of account, or other skill set or training level of the agent. As an additional example, agent routing may be based on caller ID, which may use the caller's phone number to automatically direct the caller to the appropriate person or department.

The memory 116 may store a security module 122 to avoid unnecessary exposure of user sensitive information outside a call center or outside the context of the IVR as described in more detail later herein. For example, the security module 122 may protect payment information, security codes, personal demographic data or identifiers, or other sensitive information. The IVR 120 may obtain portions of this information from the caller/user and provides this information to the security module 122. The security module 122 may obtain other portions of this information by using the user account access module 128 to access user records 160, which the user records 160 may store in an encrypted format.

The security module 122 may implement access control by requiring user authentication passwords, security questions, voice biometrics, multi-factor authentication (MFA), etc. The security module 122 may use encryption methods such as Transport Layer Security (TLS) to protect data transmitted between the caller and the IVR 120, and the security module 122 may use encryption methods such as Advanced Encryption Standard (AES) to prevent unauthorized access to stored caller/user data.

The security module 122 may implement employee access policies that control access to caller/user data. For example, the security module 122 may prevent certain employees from accessing various forms of caller/user data by associating employees with access levels in a policy database. The security module 122 may monitor access to user/caller data using audit logs.

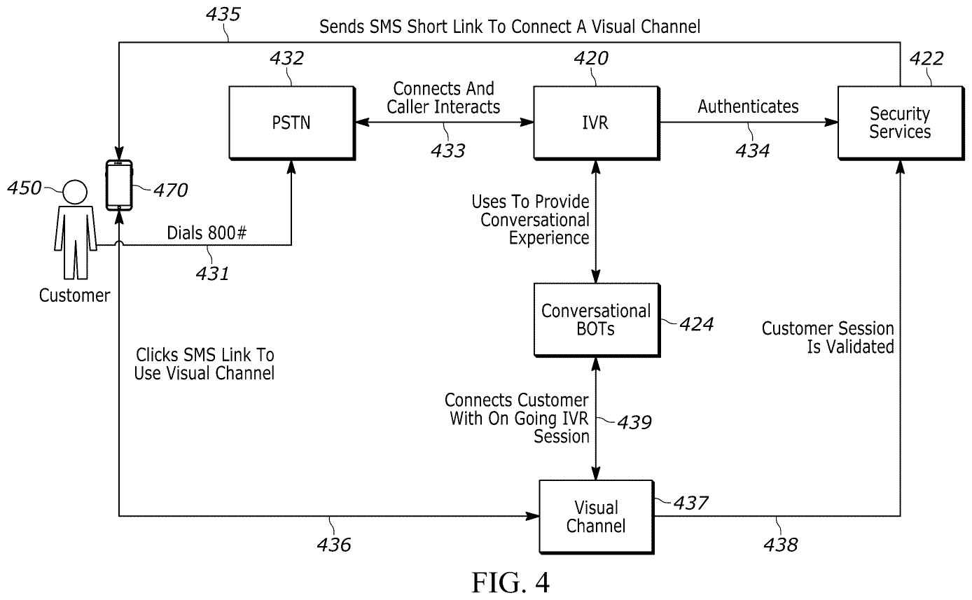

The memory 116 may include one or more conversational modules 124, which may include conversation (chat) bots to interpret voice input and to provide a conversational experience to users. The conversational module 124 may take human voice as inputs, provided via the IVR 120 or received directly from the user device 170, and the conversational module 124 can provide outputs directly to the user device 170, to the IVR 120, or to another module or system (e.g., a component illustrated in FIG. 4).

The memory 116 may include a visual channel control module 126. The visual channel control module 126 may provide access for the user device 170 to a second communication channel of a second type (e.g., visual or text input) by, e.g., generating a link that causes a web page to display allowing further detailed input from the user device 170. In some embodiments, the visual channel control module 126 may control communication on channels configured for transfer or presentation of visual data, whether separately or simultaneously with text or data channel communications as described later herein.

The client device 170 may include, by way of example, a tablet computer, a personal digital assistant (PDA), a mobile device smartphone also referred to herein as a “mobile device,” a laptop computer, a desktop computer, a portable media player, a wearable computing device, a virtual reality headset, smart glasses, a smart watch, a phablet, another smart device, a device configured for wired or wireless RF (Radio Frequency), etc. Of course, any network-enabled device appropriately configured may interact with the computing system 100. The client device 170 may communicate with the network 102 via wired or wireless signals and, in some instances, may communicate with the network 102 via an intervening wireless or wired device, which may be a wireless router, a wireless repeater, a base transceiver station of a mobile telephony provider, an optical communications device, etc. The client device 170 may be owned and/or operated by a customer or client of the company associated with the server 110.

The client device 170 may include one or more processors 172, a display 174, a communication unit 176, and a memory 178, all of which may be interconnected via an address/data bus. The memory 178 may include an operating system, a data storage, at least one software application 180, and/or a plurality of software routines. The software application(s) 180 includes user input elements to receive user calls to dial a call center, access services of the IVR 120, authenticate with the security module 122, and access text messages sent by the security module 122. The application(s) may further include web-based applications implemented or executed by the company associated with the server 110, or by a vendor associated with that company. For examples, the application(s) 180 may include a smartphone application for accessing or displaying account or service information. The operating system, for example, may include one of a plurality of mobile platforms such as the iOS®, Android™, Palm® webOS, Windows Mobile/Phone, BlackBerry® OS, or Symbian® OS mobile technology platforms, developed by Apple Inc., Google Inc., Palm Inc. (now Hewlett-Packard Company), Microsoft Corporation, Research in Motion (RIM), and Nokia, respectively.

According to embodiments, a combination of hardware and software components may store the user records data source 160. The user records data source 160 may include user financial records, account data, demographic data, and the like. The user records data source 160 may provide data to the server 110 over the network 102 using HTTP, HTTPS, a standardized or proprietary API, or any other suitable protocol.

The server 110, client device 170, and user records database 160 may communicate with each other via the network 102. The network 102 may be a proprietary network, a public Internet, a virtual private network, and/or some other type of network, such as dedicated access lines, plain ordinary telephone lines, satellite links, a wireless telephony network, combinations of these, etc. Where the network 102 includes the Internet, data communication may take place over the network 102 via an Internet communication protocol.

The server 110 and the user records data source 160 may communicate with each other over the network 102 in a secure manner using a virtual private network (VPN). The VPN may use a symmetric encryption scheme, such as advanced encryption standard (AES), to encrypt and decrypt sensitive data. The symmetric encryption keys may be exchanged in a secure manner, such as using Diffie-Hellman key exchange and/or quantum cryptography, to ensure the symmetric keys are not modified or intercepted in transit.

When a user calls into a call center, the IVR module 120 may solicit information from the user. However available solutions may not be able to solicit complex input from users, nor do available solutions provide for the IVR 120 to present complex output to the users. Therefore, when more complex input was needed from callers, previous systems were required to transfer callers to live agents. Systems and methods according to example embodiments address these and other concerns by determining when user input would be better handled over an additional or second communication channel (e.g., visual channel), and providing a way for the user to access the second communication channel. The second communication channel may allow more complex input/output to/from a user device 170. The second communication channel may be controlled using the visual channel control module 126. The first channel and the second channel are described in more detail later herein with reference to FIG. 4.

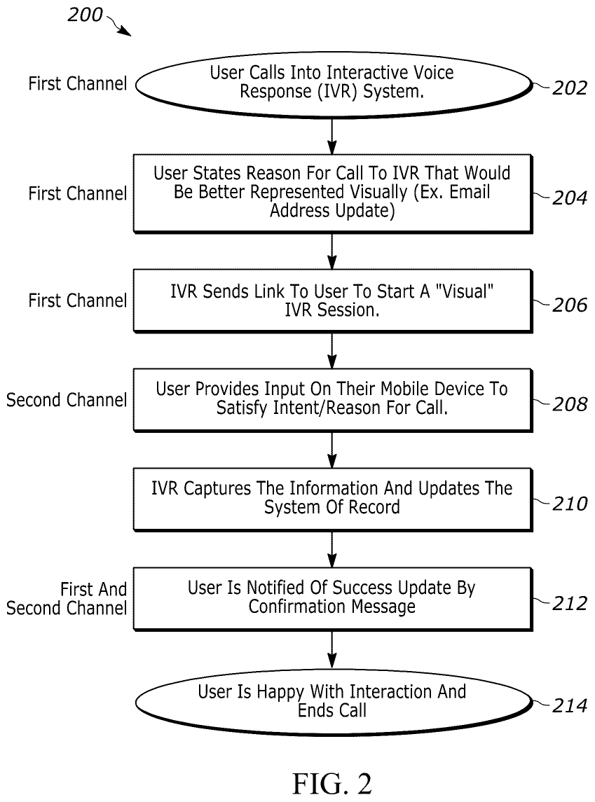

FIG. 2 illustrates a flow diagram associated with an interaction 200 of a user with a first channel and a second channel in accordance with an example aspect of the present disclosure. In some embodiments, the first communication channel enables only audio information, and the second communication channel enables at least visual interaction.

In operation 202, a customer/client/user (e.g., user device 170 (FIG. 1)) calls into the IVR (e.g., IVR 120 (FIG. 1)). For example, the user device 170 may connect to a public switched telephone network (PSTN) using, for example, wireless communication, or other communication type.

In operation 204, the user device 170 receives verbal user input via microphone or keypad user input via a touchscreen keypad or physical keypad. In either case, the input may include a reason for the call. The IVR 120 may use automatic speech recognition (ASR), natural language processing (NLP), etc. to recognize user speech, or the IVR 120 may use keypad input processing to recognize user keypresses. The input may indicate that further input is better represented visually. For example, the input may indicate a user desire to enter an email address or enter other data that is difficult to understand or that may be easily misinterpreted when input by voice or verbally.

In operation 206, the IVR 120 may provide access to a second communication channel (e.g., a visual channel) that better facilitates the interaction. For example, the IVR 120 may send a link via SMS, which the user may click to start a visual IVR session in which the user may type or otherwise enter text.

In operation 208, the user device 170 provides input that satisfies the initial reason for the call. For example, if the initial reason for the call was to update a user email address, the user device 170 may transmit, to the IVR 120, an updated email address that the user entered on a touchscreen keypad or physical keypad. In operation 210, the IVR 120 receives the information input in operation 208, and performs any backend operations, updates, etc. based on the user input of operation 208. For example, if the user input included an updated email address, the IVR 120 may update the user records 160 database with the updated email address. In operation 212, the IVR 120 may notify the user of status, e.g., success in updating user data, and the user may end the call/interaction at operation 214. The IVR 120 may perform operation 212 by transmitting text updates to the user device 170, which may then be displayed on the user device 170 display. As an additional example, the IVR 120 may transmit a verbal confirmation to the user device 170, and the user device 170 may provide the verbal confirmation to the user through the user device 170 speakers.

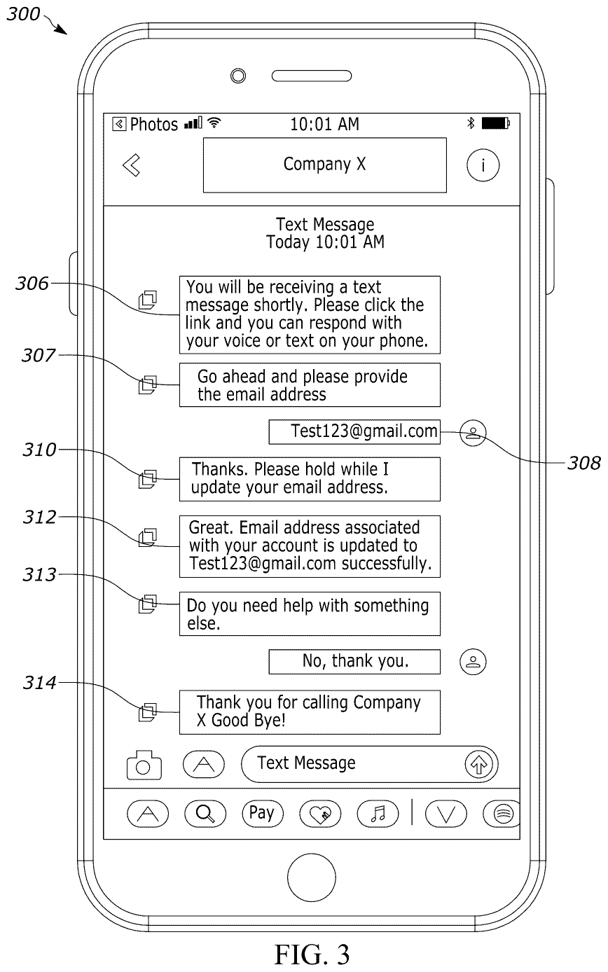

FIG. 3 illustrates a display 300 of a user device during communication with a communication service in accordance with example aspects of the present disclosure. The display 300 is one example visual depiction of some operations described with reference to FIG. 2. Operation 208 (FIG. 2) may include receiving inputs similar to those shown in element 308 (FIG. 3), etc. With the exception of the differences shown in the figures and discussed below, any of the other implementations discussed with respect to a particular event (e.g., for messaging and processing) may apply to events labeled with similar reference numbers in other figures.

Referring to FIG. 3, the IVR 120 may send texts 306 to the user device 170 to notify the user, that a text message or other communication including a link or other access mechanism will be provided, which the user should click to access visual channel elements. Once the user accesses visual channel elements (and subsequent to or based on security operations or security checks described in more detail later herein), the user device 170 may prompt 307 the user may to enter 308 or type in information. In an alternative embodiment, the user device 170 may open or display a separate application or screen (same user device showing the display 300 or a different connected user device) to allow user entry of data. In either event, the IVR 120 and the user device 170 may be in simultaneous communication over the second (visual) channel and over the first (audio/voice) channel.

In operation 310, when the user device 170 has received user input (e.g., via a touchscreen keypad) the IVR 120 may transmit an acknowledgement and/or a notification 312 regarding the user input. For example, the IVR 120 may transmit an indication that a user information update has been successfully received. The IVR 120 may transmit additional messages 313 to ask whether the user device 170 and associated user desire further interaction with the IVR 120. Then, the IVR 120 and user device 170 may end 314 the interaction. FIG. 4 illustrates messaging and data flow between modules of a computing system (e.g., the system 100 (FIG. 1) or components of server 110 (FIG. 1)) for providing a communication service in accordance with an example aspect of the present disclosure. For example, IVR 420 may be similar to IVR 120, security services 422 may be similar to security module 122, client device 170 may be similar to client device 470, etc. With the exception of the differences shown in the figures and discussed below, any of the other implementations discussed with respect to a particular event (e.g., for messaging and processing) may apply to modules labeled with similar reference numbers in other figures.

As shown in FIG. 4, a user 450 may use a device 470 to dial (431) a call center. By dialing the call center, the user device 470 may connect to a PSTN 432 using, for example, wireless communication, or other communication type. The PSTN 432 may include various types of facilities, including, but not limited to: T1 trunks (which may include multiple digital voice, data or video channels), Synchronous Optical Network (SONET)-based fiber optic networks, asynchronous transfer mode networks, etc. Various types of routers, switches, bridges, gateways, and other types of equipment may be involved in the processing of the calls. The PSTN 432 handles the call and may obtain subscriber-specific handling instructions. The PSTN 432 routes the connection 433 to the IVR 420 (also referred to herein as a verbal channel or first communication channel). The PSTN 432 maintains the connection 433 to the IVR 420 throughout at least the duration of the interaction with user 450.

The IVR 420 may play voice prompts to the device 470. The prompts may be in a menu structure, and the IVR 420 may collect and analyze responses in the forms of keypad touch tones or speech. The IVR 420 may gather information to determine the purpose of the call including prompting the user 450 to enter account information. The IVR 420 may authenticate (434) the user 450 using security services 422. In some example embodiments, security services 422 may include or implement decisions based on the user's telephone number, device 470 identifier, user verification supplied when initiating the call, or other information. User-supplied verification may include one or more of a personal identification number (PIN), date of birth, social security number or portion thereof, or other verification codes or data. Additionally, in some example embodiments, the security services 422 may tie or link a session identifier to the user, user phone number, or other user or device information. The security services 422 may implement multi-factor authentication, including usernames, passwords, personal data, one-time codes, biometrics, cryptographically encrypted information, and/or any other suitable identifiers.

When the user 450 indicates that visual or other form of data entry is desired, the security services 422 may provide (435) an SMS link that the user 450 may access or click (436) to connect to a visual IVR 437 (also referred to herein as a second communication channel or visual channel). The visual channel 437 combines a graphical user interface (GUI) with a voice channel for example by allowing text entries as shown in FIG. 3. This allows the user 450 to see available servicing options on a device 470 display, while still receiving guidance from a voice assistant as needed. The visual channel 437 may authenticate (438) the user 450 using security services 422.

The visual channel 437 may connect (439) the user 450 with an ongoing IVR session. In example embodiments, the conversational module 424 may additionally provide a conversational experience to the user 450, in conjunction with both the IVR 420 and the visual channel 437. In one embodiment, the conversational module 424 is programmed to simulate human conversation, interact with users, understand their needs, generate content (e.g., text to provide to a display), and/or recommend an appropriate line of action with minimal and/or no human intervention, among other things. This may include providing the best response of any query that it receives and/or asking follow-up questions.

In some embodiments, the conversational module 424 may be configured to utilize AI and/or ML techniques. For instance, the conversational module 424 may include one or more ChatGPT chatbots. The conversational module 424 may employ supervised or unsupervised machine learning techniques, which may be followed by, or used in conjunction with, reinforced or reinforcement learning techniques. The conversational module 424 may employ the techniques utilized for ChatGPT. The conversational module 424 may deliver various types of output for user consumption in certain embodiments, such as a dialog output, text or textual output (such as presented on a computer or mobile device screen or display), visual or graphical output, and/or other types of outputs.

The user 450 may provide verbal or written responses to complete an interaction with the call center. For example, the user 450 may call the call center to update his or her email address, to initiate a loan process, etc. The user may provide visual responses by responding to text by typing responses on the visual channel 437, while alternatively or simultaneously responding to voice commands on the IVR 420. The IVR 420 may capture the information and update the system of record. The user 450 may be notified by either or both channels upon successful completion of the initial user request. The call may be terminated upon user 450 acceptance, or the user 450 may request additional operations, whether verbally, visually, or both.

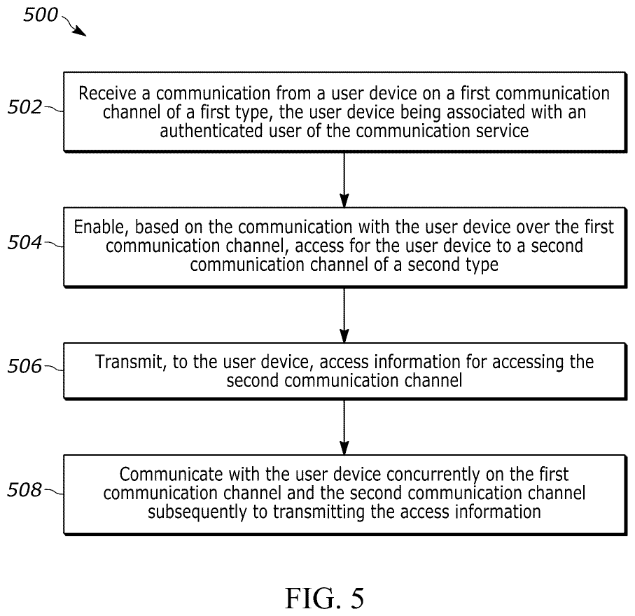

FIG. 5 depicts a flow diagram of an example computer-implemented method 500 for providing a communication service. The method 500 may operate as a stand-alone method, and/or may operate in conjunction with embodiments of at least a portion of the computing system 100 and of any one or more components and/or devices related thereto, and/or with other systems, processors, databases, and/or devices. For example, the server 110 may execute at least a portion of the method 500. In some embodiments, the server 110 may execute at least a portion of the method 500 in conjunction with one or more other components of the computing system 100, such as the client device 170 and user records 160. Further, the method 500 may include additional or alternate steps other than those described with respect to FIG. 5 in embodiments.

In one embodiment, the method 500 include operation 502 with one or more processors receiving a communication from a user device 170 on a first communication channel of a first type. The user device 170 may be associated with an authenticated user of the communication service. The first communication channel of the first type may enable only audio information. The user device 170 may be associated with the authenticated user based on a phone number associated with the user device 170. The communication may include an indication of a reason for the communication and/or a request to interact with visual interactive elements. For example, the user device 170 may receive user input indicating that further input is better represented visually, and the user device 170 may transmit a request to access a visual channel.

The method 500 may include operation 504 with the one or more processors enabling, based on the communication with the user device over the first communication channel, access for the user device to a second communication channel of a second type. The second communication channel of the second type may enable at least visual interaction. In some embodiments, a transaction may be in process on the first communication channel prior to the user device accessing the second communication channel. For example, the transaction in process on the first communication channel may include text or voice responses regarding a user account, responses to complete a financial transaction, etc.

The method 500 may include operation 506 with the one or more processors transmitting, to the user device 170, access information for accessing the second communication channel. The access information may be provided by transmitting a hypertext link for accessing the second communication channel via visual interaction elements. The method 500 may further include pre-populating user information for the authenticated user to the visual interaction elements. The method 500 may further include displaying the user information on the visual interaction elements. The method 500 may include pre-populating context information for a transaction to the visual interaction elements and displaying the context information. For example, when the user device 170 is a smartphone executing a smartphone application associated with a user account or service provider, fields within the smartphone application may be pre-populated with a user name, phone number, email address, etc. of the authenticated user.

The method 500 may include operation 508 with the one or more processors communicating with the user device 170 concurrently on the first communication channel and the second communication channel subsequently to transmitting the access information.

The method 500 may include performing an authentication process of the user device 170 prior to receiving the communication on the first communication channel of the first type; generating an authentication token; and accessing the authentication token to determine whether to enable access to the second communication channel.

This detailed description is to be construed as exemplary only and does not describe every possible embodiment, as describing every possible embodiment would be impractical, if not impossible. One may implement numerous alternate embodiments, using either current technology or technology developed after the filing date of this application.

Although the present disclosure sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a processor configured using software, the processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a business or home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed:

1. A computer-implemented method for providing a communication service, the method comprising:
receiving, by one or more processors, a communication from a user device on a first communication channel of a first type, the user device being associated with an authenticated user of the communication service;
enabling, by the one or more processors and based on the communication with the user device over the first communication channel, access for the user device to a second communication channel of a second type;
transmitting, to the user device by the one or more processors, access information for accessing the second communication channel; and
communicating, by the one or more processors, with the user device concurrently on the first communication channel and the second communication channel subsequently to transmitting the access information.

2. The method of claim 1, wherein the first communication channel of the first type enables only audio information.

3. The method of claim 1, wherein the second communication channel of the second type enables at least visual interaction.

4. The method of claim 3, wherein:
the user device is associated with the authenticated user based on a phone number associated with the user device.

5. The method of claim 1, wherein transmitting access information includes providing a hypertext link for accessing the second communication channel via visual interaction elements.

6. The method of claim 5, further comprising:
pre-populating, by the one or more processors, user information for the authenticated user to the visual interaction elements; and
displaying, by a display, the user information on the visual interaction elements.

7. The method of claim 5, further comprising:
pre-populating context information for a transaction to the visual interaction elements; and
displaying, by a display, the context information.

8. The method of claim 7, wherein the transaction is in process on the first communication channel prior to the user device accessing the second communication channel.

9. The method of claim 1, wherein the communication includes an indication of a reason for the communication.

10. The method of claim 1, wherein the communication further includes a request to interact with visual interactive elements.

11. A computing system for providing a communication service, the system comprising:
one or more processors; and
one or more non-transitory memories, the one or more non-transitory memories having stored thereon computer-executable instructions that, when executed by the one or more processors, cause the one or more processors to:
receive a communication from a user device on a first communication channel of a first type, the user device being associated with an authenticated user of the communication service;
enable, based on the communication with the user device over the first communication channel, access for the user device to a second communication channel of a second type;
transmit, to the user device, access information for accessing the second communication channel; and
communicate with the user device concurrently on the first communication channel and the second communication channel subsequently to transmitting the access information.

12. The computing system of claim 11, wherein:
the first communication channel of the first type enables only audio information, and
the second communication channel of the second type enables at least visual interaction.

13. The computing system of claim 11, wherein instructions for transmitting access information include instructions for providing a hypertext link for accessing the second communication channel via visual interaction elements.

14. The computing system of claim 13, wherein instructions further comprise instructions to:
pre-populate user information for the authenticated user to the visual interaction elements; and
provide the user information for display on the visual interaction elements.

15. The computing system of claim 13, wherein instructions further comprise instructions to:
pre-populate context information for a transaction to the visual interaction elements; and
provide the context information to a display.

16. The computing system of claim 13, wherein instructions further comprise instructions to:
pre-populate context information for a transaction to the visual interaction elements; and
display the context information, wherein the transaction is in process on the first communication channel prior to the user device accessing the second communication channel.

17. A computer-readable medium including instructions that, when executed on a processor, cause the processor to perform operations for providing a communication service, the operations comprising:
receiving a communication from a user device on a first communication channel of a first type, the user device being associated with an authenticated user of the communication service;
enabling, based on the communication with the user device over the first communication channel, access for the user device to a second communication channel of a second type;
transmitting, to the user device, access information for accessing the second communication channel; and
communicating with the user device concurrently on the first communication channel and the second communication channel subsequently to transmitting the access information.

18. The computer-readable medium of claim 17, wherein the first communication channel of the first type enables only audio information.

19. The computer-readable medium of claim 17, wherein the second communication channel of the second type enables at least visual interaction.

20. The computer-readable medium of claim 17, wherein transmitting access information includes providing a hypertext link for accessing the second communication channel via visual interaction elements, and wherein the operations further comprise pre-populating user information for the authenticated user to the visual interaction elements; and providing the user information for display on the visual interaction elements.
